(19) United States
(12) Patent Application Publication
(10) Pub. No.: US 2026/0333048 A1
(43) Pub. Date: Oct. 22, 2026

(54) FEDERATED LEARNING GROUP AUTHORIZATION OF NETWORK DATA ANALYTICS FUNCTIONS IN 5G CORE

(71) Applicant: INTEL CORPORATION, Santa Clara, CA (US)

(72) Inventors: Abhijeet KOLEKAR, Leander, TX (US); Yi ZHANG, San Jose, CA (US); Meghashree Dattatri KEDALAGUDDE, Portland, OR (US)

(73) Assignee: INTEL CORPORATION, Santa Clara, CA (US)

(21) Appl. No.: 19/119,077

(22) PCT Filed: Nov. 1, 2023
(86) PCT No.: PCT/US2023/078392

§ 371 Date: Apr. 7, 2025

Related U.S. Application Data
(60) Provisional application No. 63/422,733, filed on Nov. 4, 2022.

(51) Int. Cl. H04W 12/084; H04W 12/06

(52) U.S. Cl. CPC H04W 12/084; H04W 12/06

(57) ABSTRACT

This disclosure describes systems, methods, and devices related to federated learning (FL) group authorization. A device may receive a request for an access token from a network function (NF) service consumer to request network data analytics function (NWDAF) model training logical function (MTLF) (federated learning (FL) Server) services. The device may validate the access token associated with the NWDAF. The device may initiate an FL group based on the validated access token. The device may start the FL group for analytics identification (ID). The device may send a request to get an NF repository function (NRF) access token from an NRF. The device may perform global model updates and aggregation. The device may provide an NF service response to the NF service consumer.

### CROSS-REFERENCE TO RELATED PATENT APPLICATION(S)

This application claims the benefit of U.S. Provisional Application No. 63/422,733, filed Nov. 4, 2022, the disclosure of which is incorporated herein by reference as if set forth in full.

### TECHNICAL FIELD

This disclosure generally relates to systems and methods for wireless communications and, more particularly, to federated learning (FL) Group Authorization of network data analytics function (NWDAF) in 5G core (5GC).

### BACKGROUND

Wireless devices are becoming widely prevalent and are increasingly requesting access to wireless channels. The 3rd Generation Partnership Project (3GPP) is a pivotal organization responsible for defining and evolving the architecture of mobile communication systems. Within this framework, Technical Specification Group SA Working Group 2 (SA2) plays a significant role in shaping the overarching system architecture, encompassing various elements like User Equipment, Access Network, Core Network, and IP Multimedia Subsystem. Further, SA3 focuses on authorization processes related to this integration. These collective efforts drive the continuous advancement of the 3GPP network, ensuring it remains at the forefront of mobile communications technology.

### BRIEF DESCRIPTION OF THE DRAWINGS

FIG. 1 depicts an illustrative schematic diagram for federated learning (FL) group authorization, in accordance with one or more example embodiments of the present disclosure.

FIG. 2 illustrates a flow diagram of illustrative process for an illustrative FL group authorization system, in accordance with one or more example embodiments of the present disclosure.

FIG. 3 illustrates an example network architecture, in accordance with one or more example embodiments of the present disclosure.

FIG. 4 schematically illustrates a wireless network, in accordance with one or more example embodiments of the present disclosure.

FIG. 5 illustrates components of a computing device, in accordance with one or more example embodiments of the present disclosure.

FIG. 6 illustrates a network in accordance with various embodiments.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims. The technical problem that needs resolution is the following:

Technical Specification Group SA Working Group 2 (SA2) is in charge of developing the overall 3GPP system architecture and services including User Equipment, Access Network, Core Network, and IP Multimedia Subsystem. 3GPP SA2 studies the architecture enhancement to support Federated Learning which allows the cooperation of multiple NWDAFs containing MTLF to train an ML model in 3GPP network. Meanwhile, SA3 studies the authorization aspect of including participant NWDAF instances in the Federated Learning group. It requires the authorization of selection of participant NWDAF instances in the Federated Learning group shall be supported:
A server NWDAF shall be authorized to include a client NWDAF into a Federated Learning group.
A client NWDAF shall be authorized to join a Federated Learning group.

This existing authorization scheme defined by 3GPP for SBA can be applied to FL scenario as well, i.e., NWDAF AnLF or MTLF (Service consumer) gets the token of an authenticated NWDAF MTLF (FL Server) from NRF, and then presents this token to NWDAF MTLF (FL Server). NWDAF MTLF (FL Server) trusts the NWDAF AnLF ( ) and allows it to access to all its services after verifies this token. Similar procedure for the NWDAF MTLF (FL Server) accessing to the services of NWDAF MTLF (FL Client).

However, the above-mentioned requirement of authorization in a FL group requires a finer authorization granularity on one specific FL group, rather than the existing network function level authorization. For example, a server NWDAF may not support FL model aggregation for all Analytics IDs it supports. Similarly, a client NWDAF may not support FL for all Analytics IDs it supports.

Terms in this disclosure:

FL: federated learning. NWDAF MTLF (FL Server): NWDAF containing MTLF and supporting model aggregation for FL. NWDAF MTLF (FL Client): NWDAF containing MTLF and supporting local training for FL. NWDAF AnLF (Service consumer): NWDAF containing AnLF functionality.

Authorization scheme defined by 3GPP for service-based architecture (SBA) is a token-based authorization for access of network function (NF) service consumers to the services offered by NF service producers, which is based on OAuth 2.0. Each NF registers itself to NF repository function (NRF). NRF issues access tokens to NF service consumers after previous authentication of the consumer. The NF service consumer then presents the access token to the NF service producer when invoking a service. The NF service producer first validates the access token before granting the NF service consumer access to its services.

The current authorization scheme defined by 3GPP for SBA works only at network function level, or service level or resource/operation-level scope. This authorization granularity may be not sufficient in the FL group scenario.

Example embodiments of the present disclosure relate to systems, methods, and devices for federated learning (FL) group authorization of NWDAF(s) in 5G Core (5GC). 5GC is the heart of a 5G network, controlling data and control plane operations. The 5G core aggregates data traffic, communicates with UE, delivers essential network services and provides extra layers of security, among other functions.

In one embodiment, a FL group authorization system may facilitate a solution to allow server NWDAF and client NWDAF authorization for a specific Federated Learning group. Enable a finer granularity of authorization for a specific FL group.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

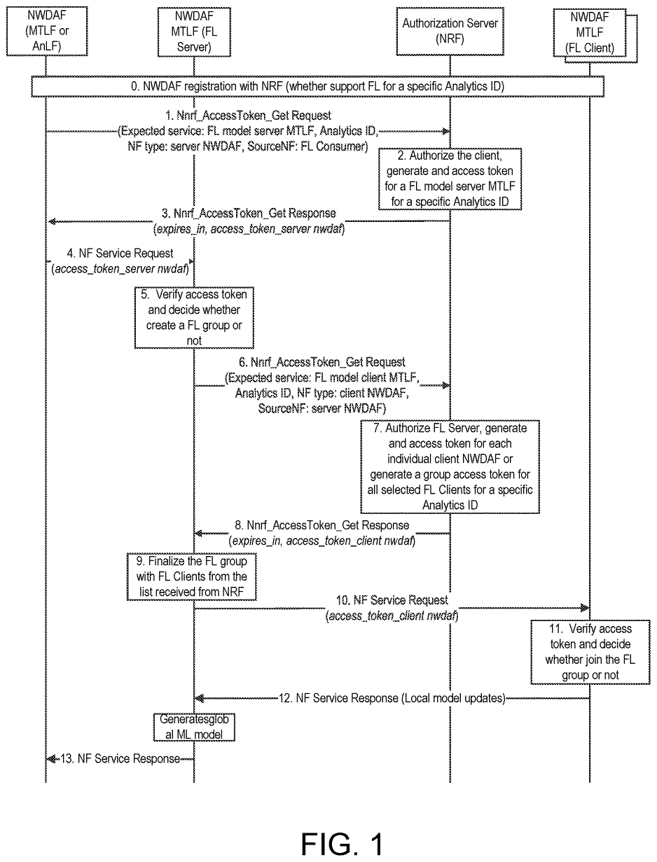

FIG. 1 depicts an illustrative schematic diagram for FL group authorization, in accordance with one or more example embodiments of the present disclosure.

The 5G System is designed to be AI-enabled, focusing on efficient resource allocation and usage across the network. Its analytics capabilities, encapsulated in the network data analytics function (NWDAF), are segregated from other core functions for enhanced modularity.

The NWDAF serves as an integral component within the 5G network architecture, responsible for the centralized aggregation and analysis of data from diverse sources. These sources include various 5G Core network functions, application functions, as well as Operations, Administration, and Management (OAM) systems. NWDAF leverages this data to generate actionable insights into network performance, security, and customer experience. Specifically, it monitors key performance indicators such as latency, throughput, and resource availability, aiding in the identification and troubleshooting of network issues. Furthermore, it conducts security analyses to pinpoint potential vulnerabilities, thereby enhancing network security. NWDAF also plays a crucial role in customer experience optimization by analyzing consumer data to discern trends and patterns. It even facilitates closed-loop automation by generating real-time alerts for performance lapses or security threats. Functionally, NWDAF supports data collection from network functions (NFs) and application functions (AFs), offers service registration and metadata exposure, and provides analytics information to these entities. It also supports machine learning model training, specifically within its Analytics Logical Function, to further enhance its analytics capabilities. This invention is pivotal for optimizing network performance, fortifying security, and elevating the customer experience.

There are two distinct NWDAF functionalities: analytics logical function (AnLF) and model training logical function (MTLF). NWDAF AnLF is responsible for collecting the analytical request and sending the response to the consumer. AnLF requires the model endpoints, which is provided by the MTLF. NWDAF MTLF trains and deploys the model inference microservice. NWDAF takes charge of data collection and storage for inference, and can collaborate with other functions to fulfill this role. It typically employs multiple machine learning models, necessitating an iterative development process that involves continuous monitoring and retraining, especially as overlapping data feeds into these models.

FL may be integrated into the architecture of multiple NWDAFs equipped with MTLF. Unlike conventional centralized ML approaches that consolidate all local datasets onto a singular server, FL allows for ML model training across various decentralized NWDAFs without sharing local datasets. This architecture addresses key challenges like data privacy, security, and access rights. Within this ecosystem, one NWDAF with MTLF serves as the FL server (termed FL Server NWDAF), while others act as FL clients (termed FL Client NWDAFs). The FL Server NWDAF is tasked with selecting client NWDAFs, requesting local model training, and aggregating this local model data to formulate a global ML model. This global model is then sent back to the FL Client NWDAFs for additional training if needed. On the other hand, FL Client NWDAFs are responsible for local ML model training on non-sharable data, and they report these local models back to the FL Server NWDAF. The model is iteratively refined based on global feedback, offering a secure and efficient approach to ML model optimization.

NWDAF MTLF (FL Server) can select which Federated Learning task it wants to create by verifying the access token presented by the NWDAF AnLF. NWDAF MTLF (FL Client) can select which Federated Learning group it wants to join by verifying the access token presented by the NWDAF MTLF (FL Server). Consequently, the following additional requirements are present:
Authorization shall be provisioned and verified at the Federated Learning group level, i.e., per Analytics ID for which ML model can be trained with FL.
Both NWDAF MTLF (FL Server) and NWDAF MTLF (FL Client) are able to set limit of the compute resource for each FL group. These criteria may be determined as part of the NWDAF (MTLF or AnLF) local configuration independently depending on the operator requirements.

Both NWDAF MTLF (FL Server) and NWDAF MTLF (FL Client) shall register themselves to NRF with their FL related information, including Analytics ID(s), Address information, FL capability Type (i.e. FL server or FL clients), and Service Area, etc. Besides that information, the following info are also required for FL service discovery and FL groups authorization:
Whether ML model training with FL is supported for each Analytics ID.
Maximum compute resource percentage could be assigned for the FL group for this Analytics ID.

NRF issues access token to NWDAF AnLF (e.g., NWDAF with AnLF) only when the NWDAF MTLF (FL Server) supports global model aggregation for the requested Analytics ID i.e., the MTLF supports FL server capability for a given Analytics ID(s) and optionally available compute resource can meet the model training requirement. Similarly, NRF issues access token to NWDAF MTLF (FL Server) only when the NWDAF MTLF (FL Client) supports FL based model training for the requested Analytics ID i.e., the MTLF supports FL client capability for a given Analytics ID(s) and optionally available compute resource can meet the model training requirement. There are two options for the token assignment:
1. One shared token for all members in the FL group.
2. Individual token for each FL server and FL clients.

The detailed procedure for NWDAF AnLF/NWDAF MTLF (FL Server) to get token from NRF and receive services from NWDAF MTLF (FL Server)/NWDAF MTLF (FL Client) is depicted in FIG. 1.
0. NWDAF registers with NRF. If NWDAF MTLF as FL server determines ML model requires FL, the FL Server discovers and selects other NWDAF(s) MTLF as FL Client(s) from NRF. If NWDAF MTLF without FL server capability determines ML model requires FL, the MTLF discovers and selects FL sever from NRF.
1-3. NF (NWDAF AnLF or MTLF) Service Consumer sends a request to the NRF to receive an access token to request services of NWDAF MTLF (FL Server). NRF after verifying generates access token and sends it to the NF (NWDAF ANLF OR MTLF) Service Consumer. Access token contain NWDAF MTLF (FL Server specific token).
4 The NF (NWDAF AnLF OR MTLF) Service Consumer initiates a NF service request to the NWDAF MTLF (FL Server) which includes the access_token_nwdaf. The NF (NWDAF AnLF OR MTLF) Service Consumer also generates a client credentials assertion (CCA) token (CCA_NWDAF) as described in the clause 13.3.8 of TS 33.501 and include it in the request message in order to authenticate itself towards the NF Service Producers.

In some embodiment, the services provided by the NWDAF MTLF with server capability may be Nnwdaf_MLModelProvision services and the access_token_nwdaf provided by the NRF is provided for this service. Nnwdaf_MLModelProvision service enables the consumer to receive a notification when an ML model matching the subscription parameters becomes available, and Nnwdaf MLModelInfo service enables the consumer to request and get from NWDAF containing MTLF ML Model Information.

In other embodiment, the new service provided by the MWDAF MTLF with server capability is defined i.e., Nnwdaf_MLModelTraining services or Nnwdaf_MLModel_DistributedTraining services and the access_token_nwdaf provided by the NRF is provided for this service. The NWDAF_MLModelTraining service, is provided by the NWDAF containing MTLF. This service allows the NF service consumers to subscribe to and unsubscribe from different ML model training events, allows the NF service consumers to modify different ML model training events, and notifies the NF service consumers with a corresponding subscription about ML model information. The

Nnwdaf_MLModel_DistributedTraining is a service operation that allows an NWDAF service consumer to request information about ML model training based on the ML model provided by the service consumer. The service may be used by an NWDAF containing MTLF to enable e.g. Federated Learning. The service operation consists of the following steps:
The NWDAF service consumer sends a request to the NWDAF containing MTLF.
The NWDAF containing MTLF determines whether the set of ML Model(s) associated with a/an (set of) Analytics ID(s) should be retrieved from the ADRF.
When NWDAF containing MTLF authorizes the NF consumer to retrieve the ML model(s) stored in the ADRF, the NWDAF containing MTLF replies to the NWDAF service consumer with the information about the ML model training.
5. The NWDAF MTLF (FL Server) verifies if the access_token_nwdaf is valid and starts FL group.
6 If The NWDAF MTLF (FL Server) determines to start the FL group for analytics id, The NWDAF MTLF (FL Server) sends a Nnrf_AccessToken_Get request to NRF including the information to identify the target NF (NWDAF MTLF (FL Client)), the source NF (NWDAF AnLF OR MTLF) Service Consumer), the NF Instance ID of NWDAF MTLF (FL Server), Analytics ID, FL local model training service type, FL group ID and the CCA_NWDAF provided by the NF (NWDAF AnLF OR MTLF) Service Consumer.

In some embodiment, the services provided by the NWDAF MTLF with client capability may be Nnwdaf_MLModelProvision services and the access_token_nwdaf provided by the NRF is provided for this service.

In other embodiment, the new service provided by the MWDAF MTLF with client capability is defined i.e., Nnwdaf_MLModelTraining services or Nnwdaf_MLModel_DistributedTraining services and the access_token_nwdaf provided by the NRF is provided for this service.
7. The NRF checks whether the NWDAF MTLF (FL Server) and the NF (NWDAF ANLF OR MTLF) Service Consumer (e.g. NWDAF) are allowed to access the service provided by the identified NF Service Producers (NWDAF MTLF (FL Client)) for the given Analytics ID included in step 6, and the NWDAF MTLF (FL Server) as the proxy is allowed to request the service from the identified NF Service Producers on behalf the NF (NWDAF ANLF OR MTLF) Service Consumer. NRF authenticates both NWDAF MTLF (FL Server) and NWDAF (FL consumer e.g AnLF) based on one of the SBA methods described in clause 13.3.1.2 of TS 33.501. NWDAF MTLF (FL Server) may include an additional CCA for authentication.
NOTE 1: In the case the NRF is from Rel-16 or earlier, after the NRF receives Nnrf_AccessToken_Get request, the NRF validates whether the NF (NWDAF AnLF OR MTLF) Service Consumer (e.g., NWDAF) is authorized to receive the requested service from the NF Service Producer. The NRF from Rel-16 or earlier does not validate whether the NWDAF MTLF (FL Server) is authorized to receive the requested service.
Note 2: NRF may issue one token per FL group and ML Model ID which may be common for all the Clients joining the FL group id. OR NRF may issue separate tokens for each FL client.
8. The NRF after successful verification then generates and provides an access token to the NWDAF MTLF (FL Server), the claims in the token includes the NF Instance Id of NRF (issuer), NF Instance Id of the NF Service Consumer (subject), NF type of the NF Service Producer (audience), expected service name(s), (scope), expiration time (expiration), FL group ID, Analytics ID(s), ML model ID(s) and optionally “additional scope” information (allowed resources and allowed actions (service operations) on the resources), with NF (NWDAF AnLF OR MTLF) Service Consumer Instance (subject), in order to authorize both NF (NWDAF AnLF OR MTLF) Service Consumer (e.g., NWDAF) and NWDAF MTLF (FL Server) to consume the services of NWDAF MTLF (FL Client).
NOTE 2: In the case the NRF is from Rel-16 or earlier, the NRF generates an OAuth2.0 access token with “subject” claim mapped to the NF (NWDAF AnLF OR MTLF) Service Consumer (e.g., NWDAF) and no additional claim for the NWDAF MTLF (FL Server) identity is added.
9. NWDAF MTLF (FL Server) finalize the FL group with NWDAF MTLF (FL Client) selected from the list received from NRF.10. The NWDAF MTLF (FL Server) requests service (local model updates) from the NWDAF MTLF (FL Client). The request also consists of CCA_NWDAF, so that the NF Service Producer(s) authenticates the NF (NWDAF ANLF OR MTLF) Service Consumer (e.g., NWDAF).

In some embodiment, the services provided by the NWDAF MTLF with client capability may be Nnwdaf_MLModelProvision services.

In other embodiment, the new service provided by the MWDAF MTLF with client capability is defined i.e., Nnwdaf_MLModelTraining services Nnwdaf_MLModel_DistributedTraining services.
11. The NWDAF MTLF(s) (FL client) authenticates the NF (NWDAF AnLF OR MTLF) Service Consumer and verify the access token and ensures that the NWDAF MTLF (FL Server) identity,FL group ID, Analytics ID(s), ML model ID(s) is included as an access token additional claim.
12. The NWDAF MTLF(s) (FL client) provides requested data to the NWDAF MTLF (FL Server). Global Model updates/aggregation is done at NWDAF MTLF (FL Server).
13. NWDAF MTLF (FL Server) feedback the NF Service Response.

In various scenarios, the device may facilitate a process where the NF (NWDAF ANLF or MTLF) Service Consumer initiates a request directed towards the NRF, seeking an access token for the purpose of soliciting services from NWDAF MTLF (FL Server). Following successful verification by the NRF, an access token may be generated and forwarded to the NF (NWDAF ANLF OR MTLF) Service Consumer, containing NWDAF MTLF (FL Server) specific credentials.

Continuing from the previous context, the device may engage in a situation wherein the NF (NWDAF ANLF OR MTLF) Service Consumer initiates a request for NF services from the NWDAF MTLF (FL Server), incorporating the access_token_nwdaf. Additionally, the NF (NWDAF ANLF OR MTLF) Service Consumer may generate a Client Credentials Assertion (CCA) token (CCA_NWDAF) and include it within the request message to authenticate itself towards the NF Service Producers.

In alignment with these processes, illustrative examples may involve the NWDAF MTLF offering services characterized as Nnwdaf_MLModelProvision services, with the access_token_nwdaf from the NRF designated for these services. Additionally, scenarios may arise where the NWDAF MTLF introduces new services with server capabilities, such as Nnwdaf_MLModelTraining services or Nnwdaf_MLModel_DistributedTraining services, for which the access_token_nwdaf provided by the NRF is allocated.

The device may also oversee the validation of the access_token_nwdaf by the NWDAF MTLF (FL Server), followed by the initiation of FL group activities if the validation is successful. In such cases, if the NWDAF MTLF (FL Server) decides to commence the FL group for analytics id, it may send a Nnrf_AccessToken_Get request to the NRF, containing information essential for identifying the target NF (NWDAF MTLF (FL Client)), the source NF (NF (NWDAF ANLF OR MTLF) Service Consumer), the NF Instance ID of NWDAF MTLF (FL Server), Analytics id, FL local model training service type, FL group ID, and the CCA_NWDAF provided by the NF (NWDAF ANLF OR MTLF) Service Consumer.

Expanding upon these processes, some embodiments may involve the NWDAF MTLF with client capabilities providing services, such as Nnwdaf_MLModelProvision services, and utilizing the access_token_nwdaf provided by the NRF for this purpose. Similarly, alternative embodiments might include the definition of new services by the NWDAF MTLF with client capabilities, such as Nnwdaf_MLModelTraining services or Nnwdaf_MLModel_DistributedTraining services, with the access_token_nwdaf from the NRF designated for utilization in these newly defined services.

Furthermore, the NRF assumes the responsibility of verifying whether the NWDAF MTLF (FL Server) and the NF (NWDAF ANLF OR MTLF) Service Consumer (e.g., NWDAF) possess the necessary permissions to access services provided by the identified NF Service Producers (NWDAF MTLF (FL Client)) for the given Analytics ID.

Following successful verification by the NRF, it proceeds to generate and provide an access token to the NWDAF MTLF (FL Server). This access token may encompass various claims, including the NF Instance Id of NRF (issuer), NF Instance Id of the NF Service Consumer (subject), NF type of the NF Service Producer (audience), expected service name(s) (scope), expiration time (expiration), FL group ID, Analytics ID(s), ML model ID(s), and optionally “additional scope” information (allowed resources and allowed actions (service operations) on the resources), with NF (NWDAF ANLF OR MTLF) Service Consumer Instance (subject).

In the course of these interactions, the NWDAF MTLF (FL Server) may request services involving local model updates from the NWDAF MTLF (FL Client), and this request may include CCA_NWDAF, allowing the NF Service Producer(s) to authenticate the NF (NWDAF ANLF OR MTLF) Service Consumer (e.g., NWDAF).

Expanding upon this, the Client NWDAF FL(s) may authenticate the NF (NWDAF ANLF OR MTLF) Service Consumer and verify the access token. Additionally, the access token may include the NWDAF MTLF (FL Server) identity, FL group ID, Analytics ID(s), and ML model ID(s) as an additional claim. Concluding this sequence, the Client NWDAF FL(s) furnish the requested data to the NWDAF MTLF (FL Server), and Global Model updates and aggregation activities may be executed at the NWDAF MTLF (FL Server).

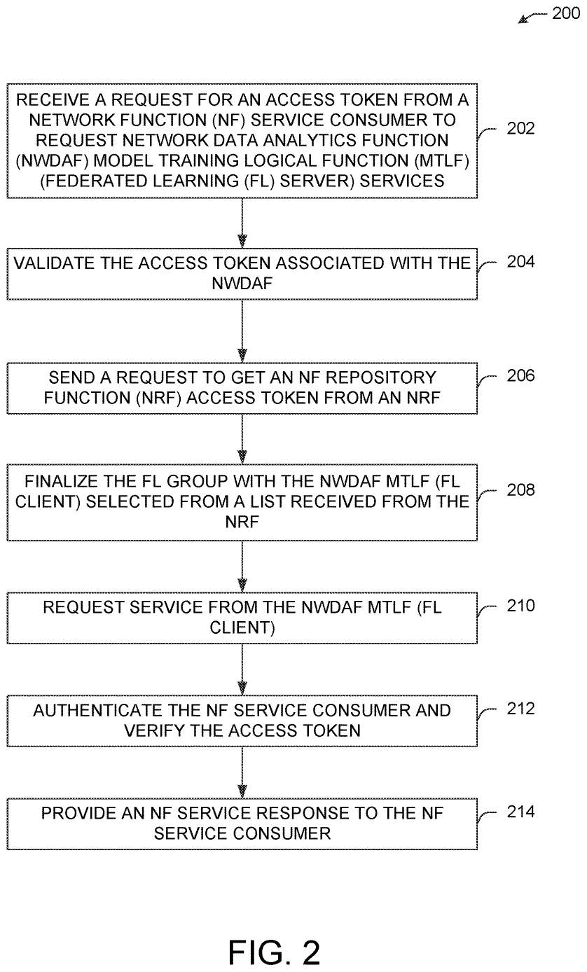

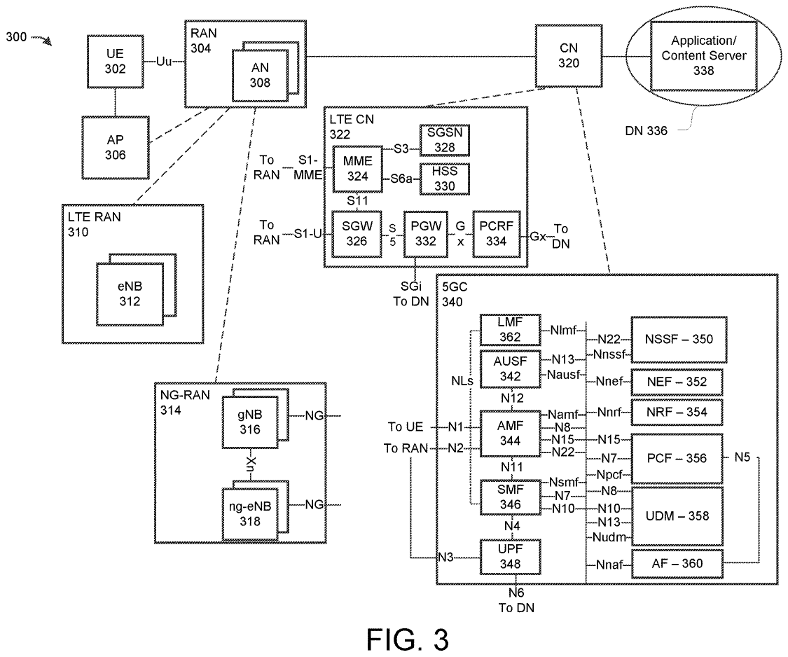

In some embodiments, the electronic device(s), network(s), system(s), chip(s) or component(s), or portions or implementations thereof, of FIGS. 3-5, or some other figure herein, may be configured to perform one or more processes, techniques, or methods as described herein, or portions thereof. One such process is depicted in FIG. 2.

For example, the process may include, at 202, receiving a request for an access token from a network function (NF) service consumer to request network data analytics function (NWDAF) model training logical function (MTLF) (federated learning (FL) Server) services.

The process further includes, at 204, validating the access token associated with the NWDAF.

The process further includes, at 206, sending a request to get an NF repository function (NRF) access token from an NRF.

The process further includes, at 208, finalizing the FL group with the NWDAF MTLF (FL Client) selected from a list received from the NRF.

The process further includes, at 210, requesting service from the NWDAF MTLF (FL Client).

The process further includes, at 212, authenticate the NF service consumer and verify the access token.

The process further includes, at 214, providing an NF service response to the NF service consumer.

The device may include an apparatus where the NF service consumer can take the form of an NWDAF AnLF or MTLF service consumer, as described above. Additionally, the access token utilized within this apparatus may be referred to as an access_token_nwdaf. Furthermore, the NRF access token, which plays a pivotal role in identifying the target NF (NWDAF MTLF (FL Client)), the NF Service Consumer, NF Instance ID of NWDAF MTLF (FL Server), Analytics ID, FL local model training service type, FL group ID, and a CCA_NWDAF provided by the NF service consumer, may contain relevant information for its intended use. To authenticate the NF service consumer and validate the access token, the device may entail processing circuitry with the capability to ensure the inclusion of NWDAF MTLF (FL Server) identity, FL group ID, Analytics ID(s), and ML model ID(s) within the access token. Additionally, when sending a request to obtain an NF repository function (NRF) access token from an NRF, the processing circuitry may identify specific parameters, including the target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer. Moreover, the device may be configured to provide Nnwdaf_MLModelProvision services, and it can extend its capabilities to include Nnwdaf_MLModelTraining services or Nnwdaf_MLModel_DistributedTraining services.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is understood that the above descriptions are for purposes of illustration and are not meant to be limiting.

FIG. Error! Reference source not found.-6 illustrate various systems, devices, and components that may implement aspects of disclosed embodiments.

FIG. 3 illustrates an example network architecture 300 according to various embodiments. The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 includes a UE 302, which is any mobile or non-mobile computing device designed to communicate with a RAN 304 via an over-the-air connection. The UE 302 is communicatively coupled with the RAN 304 by a Uu interface, which may be applicable to both LTE and NR systems. Examples of the UE 302 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IOT) device, and/or the like. The network 300 may include a plurality of UEs 302 coupled directly with one another via a D2D, ProSe, PC5, and/or sidelink (SL) interface. These UEs 302 may be M2M/D2D/MTC/IOT devices and/or vehicular systems that communicate using physical sidelink channels such as, but not limited to, PSBCH, PSDCH, PSSCH, PSCCH, PSFCH, etc. The UE 302 may perform blind decoding attempts of SL channels/links according to the various embodiments herein.

In some embodiments, the UE 302 may additionally communicate with an AP 306 via an over-the-air (OTA) connection. The AP 306 manages a WLAN connection, which may serve to offload some/all network traffic from the RAN 304. The connection between the UE 302 and the AP 306 may be consistent with any IEEE 802.11 protocol. Additionally, the UE 302, RAN 304, and AP 306 may utilize cellular-WLAN aggregation/integration (e.g., LWA/LWIP). Cellular-WLAN aggregation may involve the UE 302 being configured by the RAN 304 to utilize both cellular radio resources and WLAN resources.

The RAN 304 includes one or more access network nodes (ANs) 308. The ANs 308 terminate air-interface(s) for the UE 302 by providing access stratum protocols including RRC, PDCP, RLC, MAC, and PHY/LI protocols. In this manner, the AN 308 enables data/voice connectivity between CN 320 and the UE 302. The ANs 308 may be a macrocell base station or a low power base station for providing femtocells, picocells or other like cells having smaller coverage areas, smaller user capacity, or higher bandwidth compared to macrocells; or some combination thereof. In these implementations, an AN 308 be referred to as a BS, gNB, RAN node, eNB, ng-eNB, NodeB, RSU, TRxP, etc.

One example implementation is a “CU/DU split” architecture where the ANs 308 are embodied as a gNB-Central Unit (CU) that is communicatively coupled with one or more gNB-Distributed Units (DUs), where each DU may be communicatively coupled with one or more Radio Units (RUS) (also referred to as RRHs, RRUs, or the like) (see e.g., 3GPP TS 38.401 v16.1.0 (2020-03)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 308 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 304 is an LTE RAN or Evolved Universal Terrestrial Radio Access Network (E-UTRAN) 310) or an Xn interface (if the RAN 304 is a NG-RAN 314). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs 308 of the RAN 304. For example, the UE 302 and RAN 304 may use carrier aggregation to allow the UE 302 to connect with a plurality of component carriers, each corresponding to a Pcell or Scell. In dual connectivity scenarios, a first AN 308 may be a master node that provides an MCG and a second AN 308 may be secondary node that provides an SCG. The first/second ANs 308 may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an E-UTRAN 310 with one or more eNBs 312. The an E-UTRAN 310 provides an LTE air interface (Uu) with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an next generation (NG)-RAN 314 with one or more gNB 316 and/or on or more ng-eNB 318. The gNB 316 connects with 5G-enabled UEs 302 using a 5G NR interface. The gNB 316 connects with a 5GC 340 through an NG interface, which includes an N2 interface or an N3 interface. The ng-eNB 318 also connects with the 5GC 340 through an NG interface, but may connect with a UE 302 via the Uu interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN 314 and an AMF 344 (e.g., N2 interface).

The NG-RAN 314 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (e.g., PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements and/or network functions (NFs) to provide various functions to support data and telecommunications services to customers/subscribers (e.g., UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

The CN 320 may be an LTE CN 322 (also referred to as an Evolved Packet Core (EPC) 322). The EPC 322 may include MME 324, SGW 326, SGSN 328, HSS 330, PGW 332, and PCRF 334 coupled with one another over interfaces (or “reference points”) as shown. The NFs in the EPC 322 are briefly introduced as follows.

The MME 324 implements mobility management functions to track a current location of the UE 302 to facilitate paging, bearer activation/deactivation, handovers, gateway selection, authentication, etc.

The SGW 326 terminates an S1 interface toward the RAN 310 and routes data packets between the RAN 310 and the EPC 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 tracks a location of the UE 302 and performs security functions and access control. The SGSN 328 also performs inter-EPC node signaling for mobility between different RAT networks; PDN and S-GW selection as specified by MME 324; MME 324 selection for handovers; etc. The S3 reference point between the MME 324 and the SGSN 328 enable user and bearer information exchange for inter-3GPP access network mobility in idle/active states.

The HSS 330 includes a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the EPC 320.

The PGW 332 may terminate an SGi interface toward a data network (DN) 336 that may include an application (app)/content server 338. The PGW 332 routes data packets between the EPC 322 and the data network 336. The PGW 332 is communicatively coupled with the SGW 326 by an S5 reference point to facilitate user plane tunneling and tunnel management. The PGW 332 may further include a node for policy enforcement and charging data collection (e.g., PCEF). Additionally, the SGi reference point may communicatively couple the PGW 332 with the same or different data network 336. The PGW 332 may be communicatively coupled with a PCRF 334 via a Gx reference point.

The PCRF 334 is the policy and charging control element of the EPC 322. The PCRF 334 is communicatively coupled to the app/content server 338 to determine appropriate QoS and charging parameters for service flows. The PCRF 332 also provisions associated rules into a PCEF (via Gx reference point) with appropriate TFT and QCI.

The CN 320 may be a 5GC 340 including an AUSF 342, AMF 344, SMF 346, UPF 348, NSSF 350, NEF 352, NRF 354, PCF 356, UDM 358, and AF 360 coupled with one another over various interfaces as shown. The NFs in the 5GC 340 are briefly introduced as follows.

The AUSF 342 stores data for authentication of UE 302 and handle authentication-related functionality. The AUSF 342 may facilitate a common authentication framework for various access types . . .

The AMF 344 allows other functions of the 5GC 340 to communicate with the UE 302 and the RAN 304 and to subscribe to notifications about mobility events with respect to the UE 302. The AMF 344 is also responsible for registration management (e.g., for registering UE 302), connection management, reachability management, mobility management, lawful interception of AMF-related events, and access authentication and authorization. The AMF 344 provides transport for SM messages between the UE 302 and the SMF 346, and acts as a transparent proxy for routing SM messages. AMF 344 also provides transport for SMS messages between UE 302 and an SMSF. AMF 344 interacts with the AUSF 342 and the UE 302 to perform various security anchor and context management functions. Furthermore, AMF 344 is a termination point of a RAN-CP interface, which includes the N2 reference point between the RAN 304 and the AMF 344. The AMF 344 is also a termination point of NAS (N1) signaling, and performs NAS ciphering and integrity protection.

AMF 344 also supports NAS signaling with the UE 302 over an N3IWF interface. The N3IWF provides access to untrusted entities. N3IWF may be a termination point for the N2 interface between the (R) AN 304 and the AMF 344 for the control plane, and may be a termination point for the N3 reference point between the (R) AN 314 and the 348 for the user plane. As such, the AMF 344 handles N2 signalling from the SMF 346 and the AMF 344 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 302 and AMF 344 via an N1 reference point between the UE 302 and the AMF 344, and relay uplink and downlink user-plane packets between the UE 302 and UPF 348. The N3IWF also provides mechanisms for IPsec tunnel establishment with the UE 302. The AMF 344 may exhibit an Namf service-based interface, and may be a termination point for an N14 reference point between two AMFs 344 and an N17 reference point between the AMF 344 and a 5G-EIR (not shown by FIG. 3).

The SMF 346 is responsible for SM (e.g., session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM refers to management of a PDU session, and a PDU session or “session” refers to a PDU connectivity service that provides or enables the exchange of PDUs between the UE 302 and the DN 336.

The UPF 348 acts as an anchor point for intra-RAT and inter-RAT mobility, an external PDU session point of interconnect to data network 336, and a branching point to support multi-homed PDU session. The UPF 348 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 348 may include an uplink classifier to support routing traffic flows to a data network.

The NSSF 350 selects a set of network slice instances serving the UE 302. The NSSF 350 also determines allowed NSSAI and the mapping to the subscribed S-NSSAIs, if needed. The NSSF 350 also determines an AMF set to be used to serve the UE 302, or a list of candidate AMFs 344 based on a suitable configuration and possibly by querying the NRF 354. The selection of a set of network slice instances for the UE 302 may be triggered by the AMF 344 with which the UE 302 is registered by interacting with the NSSF 350; this may lead to a change of AMF 344. The NSSF 350 interacts with the AMF 344 via an N22 reference point; and may communicate with another NSSF in a visited network via an N31 reference point (not shown).

The NEF 352 securely exposes services and capabilities provided by 3GPP NFs for third party, internal exposure/re-exposure, AFs 360, edge computing or fog computing systems (e.g., edge compute node, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics.

The NRF 354 supports service discovery functions, receives NF discovery requests from NF instances, and provides information of the discovered NF instances to the requesting NF instances. NRF 354 also maintains information of available NF instances and their supported services. The NRF 354 also supports service discovery functions, wherein the NRF 354 receives NF Discovery Request from NF instance or an SCP (not shown), and provides information of the discovered NF instances to the NF instance or SCP.

The PCF 356 provides policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 handles subscription-related information to support the network entities' handling of communication sessions, and stores subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 221 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

AF 360 provides application influence on traffic routing, provide access to NEF 352, and interact with the policy framework for policy control. The AF 360 may influence UPF 348 (re) selection and traffic routing. Based on operator deployment, when AF 360 is considered to be a trusted entity, the network operator may permit AF 360 to interact directly with relevant NFs. Additionally, the AF 360 may be used for edge computing implementations,

The 5GC 340 may enable edge computing by selecting operator/3rd party services to be geographically close to a point that the UE 302 is attached to the network. This may reduce latency and load on the network. In edge computing implementations, the 5GC 340 may select a UPF 348 close to the UE 302 and execute traffic steering from the UPF 348 to DN 336 via the N6 interface. This may be based on the UE subscription data, UE location, and information provided by the AF 360, which allows the AF 360 to influence UPF (re)selection and traffic routing.

The data network (DN) 336 may represent various network operator services, Internet access, or third party services that may be provided by one or more servers including, for example, application (app)/content server 338. The DN 336 may be an operator external public, a private PDN, or an intra-operator packet data network, for example, for provision of IMS services. In this embodiment, the app server 338 can be coupled to an IMS via an S-CSCF or the I-CSCF. In some implementations, the DN 336 may represent one or more local area DNS (LADNs), which are DNs 336 (or DN names (DNNs) that is/are accessible by a UE 302 in one or more specific areas. Outside of these specific areas, the UE 302 is not able to access the LADN/DN 336.

Additionally or alternatively, the DN 336 may be an Edge DN 336, which is a (local) Data Network that supports the architecture for enabling edge applications. In these embodiments, the app server 338 may represent the physical hardware systems/devices providing app server functionality and/or the application software resident in the cloud or at an edge compute node that performs server function(s). In some embodiments, the app/content server 338 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN310, 314. For example, the edge compute nodes can provide a connection between the RAN 314 and UPF 348 in the 5GC 340. The edge compute nodes can use one or more NFV instances instantiated on virtualization infrastructure within the edge compute nodes to process wireless connections to and from the RAN 314 and UPF 348.

The interfaces of the 5GC 340 include reference points and service-based itnterfaces. The reference points include: N1 (between the UE 302 and the AMF 344), N2 (between RAN 314 and AMF 344), N3 (between RAN 314 and UPF 348), N4 (between the SMF 346 and UPF 348), N5 (between PCF 356 and AF 360), N6 (between UPF 348 and DN 336), N7 (between SMF 346 and PCF 356), N8 (between UDM 358 and AMF 344), N9 (between two UPFs 348), N10 (between the UDM 358 and the SMF 346), N11 (between the AMF 344 and the SMF 346), N12 (between AUSF 342 and AMF 344), N13 (between AUSF 342 and UDM 358), N14 (between two AMFs 344; not shown), N15 (between PCF 356 and AMF 344 in case of a non-roaming scenario, or between the PCF 356 in a visited network and AMF 344 in case of a roaming scenario), N16 (between two SMFs 346; not shown), and N22 (between AMF 344 and NSSF 350). Other reference point representations not shown in FIG. 3 can also be used. The service-based representation of FIG. 3 represents NFs within the control plane that enable other authorized NFs to access their services. The service-based interfaces (SBIs) include: Namf (SBI exhibited by AMF 344), Nsmf (SBI exhibited by SMF 346), Nnef (SBI exhibited by NEF 352), Npcf (SBI exhibited by PCF 356), Nudm (SBI exhibited by the UDM 358), Naf (SBI exhibited by AF 360), Nnrf (SBI exhibited by NRF 354), Nnssf (SBI exhibited by NSSF 350), Nausf (SBI exhibited by AUSF 342). Other service-based interfaces (e.g., Nudr, N5g-eir, and Nudsf) not shown in FIG. 3 can also be used. In some embodiments, the NEF 352 can provide an interface to edge compute nodes 336x, which can be used to process wireless connections with the RAN 314. In some implementations, the system 300 may include an SMSF, which is responsible for SMS subscription checking and verification, and relaying SM messages to/from the UE 302 to/from other entities, such as an SMS-GMSC/IWMSC/SMS-router. The SMS may also interact with AMF 344 and UDM 358 for a notification procedure that the UE 302 is available for SMS transfer (e.g., set a UE not reachable flag, and notifying UDM 358 when UE 302 is available for SMS).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501), load balancing, monitoring, overload control, etc.; and discovery and selection functionality for UDM(s), AUSF(s), UDR(s), PCF(s) with access to subscription data stored in the UDR based on UE's SUPI, SUCI or GPSI (see e.g., 3GPP TS 23.501 section 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

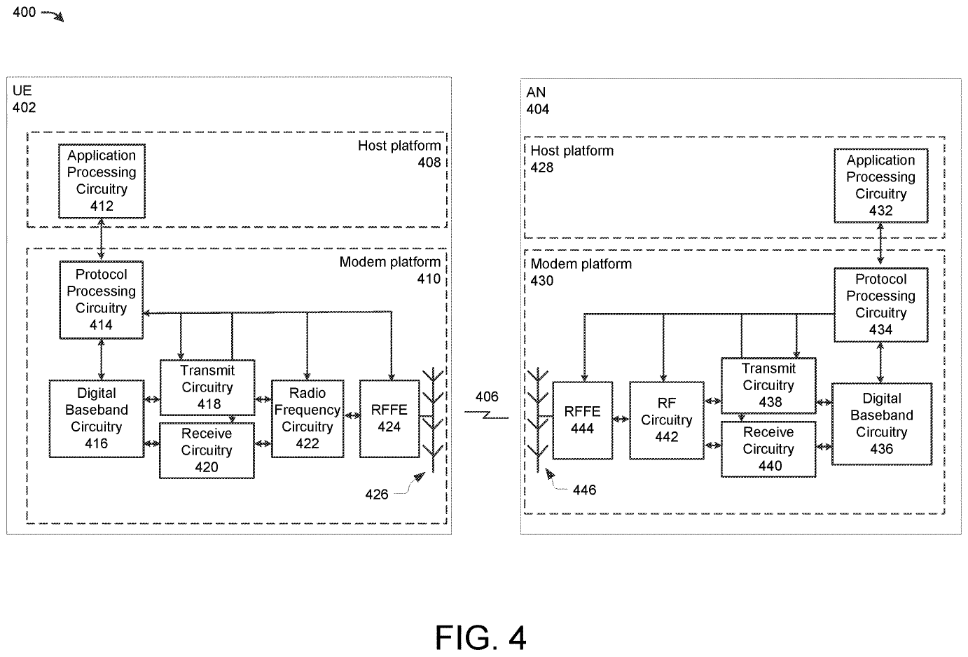

FIG. 4 schematically illustrates a wireless network 400 in accordance with various embodiments. The wireless network 400 may include a UE 402 in wireless communication with an AN 404. The UE 402 and AN 404 may be similar to, and substantially interchangeable with, like-named components described with respect to FIG. 3.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6 GHZ frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ acknowledgement (ACK) functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 418, receive circuitry 420, RF circuitry 422, RFFE 424, and antenna panels 426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE 402 reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE 402 transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

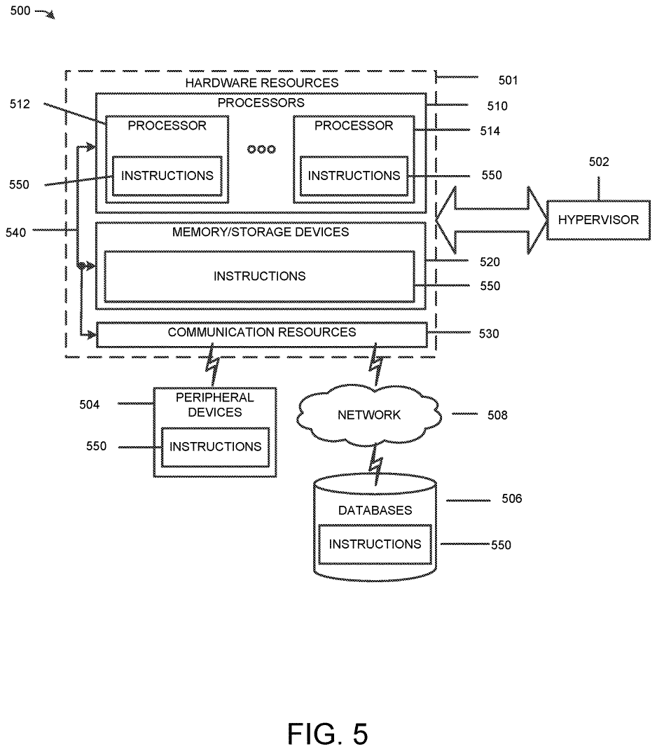

FIG. 5 illustrates components of a computing device 500 according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 501 including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources 501.

The processors 510 include, for example, processor 512 and processor 514. The processors 510 include circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. The processors 510 may be, for example, a central processing unit (CPU), reduced instruction set computing (RISC) processors, Acorn RISC Machine (ARM) processors, complex instruction set computing (CISC) processors, graphics processing units (GPUs), one or more Digital Signal Processors (DSPs) such as a baseband processor, Application-Specific Integrated Circuits (ASICs), an Field-Programmable Gate Array (FPGA), a radio-frequency integrated circuit (RFIC), one or more microprocessors or controllers, another processor (including those discussed herein), or any suitable combination thereof. In some implementations, the processor circuitry 510 may include one or more hardware accelerators, which may be microprocessors, programmable processing devices (e.g., FPGA, complex programmable logic devices (CPLDs), etc.), or the like.

The memory/storage devices 520 may include main memory, disk storage, or any suitable combination thereof. The memory/storage devices 520 may include, but are not limited to, any type of volatile, non-volatile, or semi-volatile memory such as random access memory (RAM), dynamic RAM (DRAM), static RAM (SRAM), synchronous DRAM (SDRAM), erasable programmable read-only memory (EPROM), electrically erasable programmable read-only memory (EEPROM), Flash memory, solid-state storage, phase change RAM (PRAM), resistive memory such as magnetoresistive random access memory (MRAM), etc., and may incorporate three-dimensional (3D) cross-point (XPOINT) memories from Intel® and Micron®. The memory/storage devices 520 may also comprise persistent storage devices, which may be temporal and/or persistent storage of any type, including, but not limited to, non-volatile memory, optical, magnetic, and/or solid state mass storage, and so forth.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, Ethernet, Ethernet over GRE Tunnels, Ethernet over Multiprotocol Label Switching (MPLS), Ethernet over USB, Controller Area Network (CAN), Local Interconnect Network (LIN), DeviceNet, ControlNet, Data Highway+, PROFIBUS, or PROFINET, among many others), cellular communication components, NFC components, Bluetooth® (or Bluetooth® Low Energy) components, WiFi® components, and other communication components. Network connectivity may be provided to/from the computing device 500 via the communication resources 530 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The communication resources 530 may include one or more dedicated processors and/or FPGAs to communicate using one or more of the aforementioned network interface protocols.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 501 from any combination of the peripheral devices 504 or the databases 506. Accordingly, the memory of processors 510, the memory/storage devices 520, the peripheral devices 504, and the databases 506 are examples of computer-readable and machine-readable media.

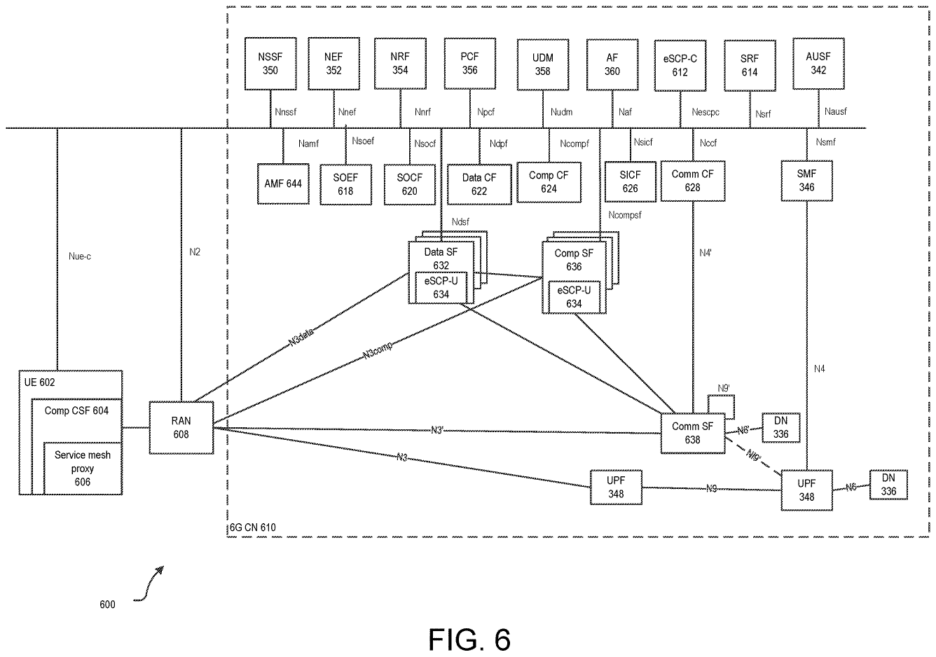

FIG. 6 illustrates a network 600 in accordance with various embodiments. The network 600 may operate in a matter consistent with 3GPP technical specifications or technical reports for 6G systems. In some embodiments, the network 600 may operate concurrently with network 300. For example, in some embodiments, the network 600 may share one or more frequency or bandwidth resources with network 300. As one specific example, a UE (e.g., UE 602) may be configured to operate in both network 600 and network 300. Such configuration may be based on a UE including circuitry configured for communication with frequency and bandwidth resources of both networks 300 and 600. In general, several elements of network 600 may share one or more characteristics with elements of network 300. For the sake of brevity and clarity, such elements may not be repeated in the description of network 600.

The network 600 may include a UE 602, which may include any mobile or non-mobile computing device designed to communicate with a RAN 608 via an over-the-air connection. The UE 602 may be similar to, for example, UE 302. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 6, in some embodiments the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 6, the UE 602 may be communicatively coupled with an AP such as AP 306 as described with respect to FIG. 3. Additionally, although not specifically shown in FIG. 6, in some embodiments the RAN 608 may include one or more ANss such as AN 308 as described with respect to FIG. 3. The RAN 608 and/or the AN of the RAN 608 may be referred to as a base station (BS), a RAN node, or using some other term or name.

The UE 602 and the RAN 608 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 608 may allow for communication between the UE 602 and a 6G core network (CN) 610. Specifically, the RAN 608 may facilitate the transmission and reception of data between the UE 602 and the 6G CN 610. The 6G CN 610 may include various functions such as NSSF 350, NEF 352, NRF 354, PCF 356, UDM 358, AF 360, SMF 346, and AUSF 342. The 6G CN 610 may additional include UPF 348 and DN 336 as shown in FIG. 6.

Additionally, the RAN 608 may include various additional functions that are in addition to, or alternative to, functions of a legacy cellular network such as a 4G or 5G network. Two such functions may include a Compute Control Function (Comp CF) 624 and a Compute Service Function (Comp SF) 636. The Comp CF 624 and the Comp SF 636 may be parts or functions of the Computing Service Plane. Comp CF 624 may be a control plane function that provides functionalities such as management of the Comp SF 636, computing task context generation and management (e.g., create, read, modify, delete), interaction with the underlaying computing infrastructure for computing resource management, etc., Comp SF 636 may be a user plane function that serves as the gateway to interface computing service users (such as UE 602) and computing nodes behind a Comp SF instance. Some functionalities of the Comp SF 636 may include: parse computing service data received from users to compute tasks executable by computing nodes; hold service mesh ingress gateway or service API gateway; service and charging policies enforcement; performance monitoring and telemetry collection, etc. In some embodiments, a Comp SF 636 instance may serve as the user plane gateway for a cluster of computing nodes. A Comp CF 624 instance may control one or more Comp SF 636 instances.

Two other such functions may include a Communication Control Function (Comm CF) 628 and a Communication Service Function (Comm SF) 638, which may be parts of the Communication Service Plane. The Comm CF 628 may be the control plane function for managing the Comm SF 638, communication sessions creation/configuration/releasing, and managing communication session context. The Comm SF 638 may be a user plane function for data transport. Comm CF 628 and Comm SF 638 may be considered as upgrades of SMF 346 and UPF 348, which were described with respect to a 5G system in FIG. 3. The upgrades provided by the Comm CF 628 and the Comm SF 638 may enable service-aware transport. For legacy (e.g., 4G or 5G) data transport, SMF 346 and UPF 348 may still be used.

Two other such functions may include a Data Control Function (Data CF) 622 and Data Service Function (Data SF) 632 may be parts of the Data Service Plane. Data CF 622 may be a control plane function and provides functionalities such as Data SF 632 management, Data service creation/configuration/releasing, Data service context management, etc. Data SF 632 may be a user plane function and serve as the gateway between data service users (such as UE 602 and the various functions of the 6G CN 610) and data service endpoints behind the gateway. Specific functionalities may include include: parse data service user data and forward to corresponding data service endpoints, generate charging data, report data service status.

Another such function may be the Service Orchestration and Chaining Function (SOCF) 620, which may discover, orchestrate and chain up communication/computing/data services provided by functions in the network. Upon receiving service requests from users, SOCF 620 may interact with one or more of Comp CF 624, Comm CF 628, and Data CF 622 to identify Comp SF 636, Comm SF 638, and Data SF 632 instances, configure service resources, and generate the service chain, which could contain multiple Comp SF 636, Comm SF 638, and Data SF 632 instances and their associated computing endpoints. Workload processing and data movement may then be conducted within the generated service chain. The SOCF 620 may also responsible for maintaining, updating, and releasing a created service chain.

Another such function may be the service registration function (SRF) 614, which may act as a registry for system services provided in the user plane such as services provided by service endpoints behind Comp SF 636 and Data SF 632 gateways and services provided by the UE 602. The SRF 614 may be considered a counterpart of NRF 354, which may act as the registry for network functions.

Other such functions may include an evolved service communication proxy (eSCP) and service infrastructure control function (SICF) 626, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 612 and eSCP-U 634, for control plane service communication proxy and user plane service communication proxy, respectively. The SICF 626 may control and configure eCSP instances in terms of service traffic routing policies, access rules, load balancing configurations, performance monitoring, etc.

Another such function is the AMF 644. The AMF 644 may be similar to 344, but with additional functionality. Specifically, the AMF 644 may include potential functional repartition, such as move the message forwarding functionality from the AMF 644 to the RAN 608.

Another such function is the service orchestration exposure function (SOEF) 618. The SOEF may be configured to expose service orchestration and chaining services to external users such as applications.

The UE 602 may include an additional function that is referred to as a computing client service function (comp CSF) 604. The comp CSF 604 may have both the control plane functionalities and user plane functionalities, and may interact with corresponding network side functions such as SOCF 620, Comp CF 624, Comp SF 636, Data CF 622, and/or Data SF 632 for service discovery, request/response, compute task workload exchange, etc. The Comp CSF 604 may also work with network side functions to decide on whether a computing task should be run on the UE 602, the RAN 608, and/or an element of the 6G CN 610.

The UE 602 and/or the Comp CSF 604 may include a service mesh proxy 606. The service mesh proxy 606 may act as a proxy for service-to-service communication in the user plane. Capabilities of the service mesh proxy 606 may include one or more of addressing, security, load balancing, etc.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Additional examples of the presently described embodiments include the following, non-limiting implementations. Each of the following non-limiting examples may stand on its own or may be combined in any permutation or combination with any one or more of the other examples provided below or throughout the present disclosure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include an apparatus for a network data analytics function (NWDAF) comprising processing circuitry configured to: receive a request for an access token from a network function (NF) service consumer to request NWDAF model training logical function (MTLF) (federated learning (FL) Server) services; validate the access token associated with the NWDAF; initiate an FL group based on the validated access token; start the FL group for analytics identification (ID); send a request to get an NF repository function (NRF) access token from an NRF; finalize the FL group with the NWDAF MTLF (FL Client) selected from a list received from the NRF; request service from the NWDAF MTLF (FL Client); authenticate the NF service consumer and verify the access token; perform global model updates and aggregation; and provide an NF service response to the NF service consumer; and a memory to store the access token.

Example 2 may include the apparatus of example 1 and/or some other example herein, wherein the NF service consumer may be an NWDAF AnLF or MTLF service consumer.

Example 3 may include the apparatus of example 1 and/or some other example herein, wherein the access token may be an access_token_nwdaf.

Example 4 may include the apparatus of example 1 and/or some other example herein, wherein the NRF access token may include information to identify the target NF (NWDAF MTLF (FL Client)), the NF Service Consumer), NF Instance ID of NWDAF MTLF (FL Server), Analytics ID, FL local model training service type, FL group ID, and a CCA_NWDAF provided by the NF service consumer.

Example 5 may include the apparatus of example 1 and/or some other example herein, wherein to authenticate the NF service consumer and verify the access token comprises the processing circuitry being further configured to ensure that the NWDAF MTLF (FL Server) identity, FL group ID, Analytics ID(s), ML model ID(s) are included as an access token.

Example 6 may include the apparatus of example 1 and/or some other example herein, wherein to wherein send a request to get an NF repository function (NRF) access token from an NRF comprises the processing circuitry being further configured to identify a target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer.

Example 7 may include the apparatus of example 1 and/or some other example herein, wherein the processing circuitry may be further configured to provide Nnwdaf_MLModelProvision services.

Example 8 may include the apparatus of example 1 and/or some other example herein, wherein the processing circuitry may be further configured to provide Nnwdaf_MLModelTraining services or Nnwdaf_MLModel_DistributedTraining services.

Example 9 may include the apparatus of example 1 and/or some other example herein, wherein the processing circuitry may be further configured to generate an access token including NF instance ID of NRF, NF Instance ID of the NF service consumer, NF type of an NF service producer, expected service name(s), expiration time, FL group ID, Analytics ID(s), and ML model ID(s).

Example 10 may include the apparatus of example 1 and/or some other example herein, wherein the processing circuitry may be further configured to include CCA_NWDAF for authentication.

Example 11 may include a computer-readable medium storing computer-executable instructions which when executed by one or more processors result in performing operations comprising: receiving a request for an access token from a network function (NF) service consumer to request network data analytics function (NWDAF) model training logical function (MTLF) (federated learning (FL) Server) services; validating the access token associated with the NWDAF; initiating an FL group based on the validated access token; starting the FL group for analytics identification (ID); sending a request to get an NF repository function (NRF) access token from an NRF; finalizing the FL group with the NWDAF MTLF (FL Client) selected from a list received from the NRF; requesting service from the NWDAF MTLF (FL Client); authenticate the NF service consumer and verify the access token; performing global model updates and aggregation; and providing an NF service response to the NF service consumer.

Example 12 may include the computer-readable medium of example 11 and/or some other example herein, wherein the NF service consumer may be an NWDAF AnLF or MTLF service consumer.

Example 13 may include the computer-readable medium of example 11 and/or some other example herein, wherein the access token may be an access_token_nwdaf.

Example 14 may include the computer-readable medium of example 11 and/or some other example herein, wherein the NRF access token may include information to identify the target NF (NWDAF MTLF (FL Client)), the NF Service Consumer), NF Instance ID of NWDAF MTLF (FL Server), Analytics ID, FL local model training service type, FL group ID, and a CCA_NWDAF provided by the NF service consumer.

Example 15 may include the computer-readable medium of example 11 and/or some other example herein, wherein the operations for authenticating the NF service consumer and verifying the access token further comprise ensuring that the NWDAF MTLF (FL Server) identity, FL group ID, Analytics ID(s), ML model ID(s) are included as an access token.

Example 16 may include the computer-readable medium of example 11 and/or some other example herein, wherein the operations for sending the request to get an NF repository function (NRF) access token from the NRF further comprise identifying a target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer.

Example 17 may include the computer-readable medium of example 11 and/or some other example herein, wherein the operations further comprise providing Nnwdaf_MLModelProvision services.

Example 18 may include the computer-readable medium of example 11 and/or some other example herein, wherein the operations further comprise providing Nnwdaf_MLModelTraining services or Nnwdaf_MLModel_DistributedTraining services.

Example 19 may include the computer-readable medium of example 11 and/or some other example herein, wherein the operations further comprise generating an access token including NF instance ID of NRF, NF Instance ID of the NF service consumer, NF type of an NF service producer, expected service name(s), expiration time, FL group ID, Analytics ID(s), and ML model ID(s).

Example 20 may include the computer-readable medium of example 11 and/or some other example herein, wherein the operations further comprise including CCA_NWDAF for authentication.

Example 21 may include a method comprising: receiving, by one or more processors, a request for an access token from a network function (NF) service consumer to request network data analytics function (NWDAF) model training logical function (MTLF) (federated learning (FL) Server) services; validating the access token associated with the NWDAF; initiating an FL group based on the validated access token; starting the FL group for analytics identification (ID); sending a request to get an NF repository function (NRF) access token from an NRF; finalizing the FL group with the NWDAF MTLF (FL Client) selected from a list received from the NRF; requesting service from the NWDAF MTLF (FL Client); authenticating the NF service consumer and verify the access token; performing global model updates and aggregation; and providing an NF service response to the NF service consumer.

Example 22 may include the method of example 21 and/or some other example herein, wherein the NF service consumer may be an NWDAF AnLF or MTLF service consumer.

Example 23 may include the method of example 21 and/or some other example herein, wherein the access token may be an access_token_nwdaf.

Example 24 may include the method of example 21 and/or some other example herein, wherein the NRF access token may include information to identify the target NF (NWDAF MTLF (FL Client)), the NF Service Consumer), NF Instance ID of NWDAF MTLF (FL Server), Analytics ID, FL local model training service type, FL group ID, and a CCA_NWDAF provided by the NF service consumer.

Example 25 may include the method of example 21 and/or some other example herein, wherein authenticating the NF service consumer and verifying the access token comprises ensuring that the NWDAF MTLF (FL Server) identity, FL group ID, Analytics ID(s), ML model ID(s) are included as an access token; Example 26 may include the method of example 21 and/or some other example herein, sending the request to get the NF repository function (NRF) access token from the NRF further comprises identifying a target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer.

Example 27 may include the method of example 21 and/or some other example herein, further comprising providing Nnwdaf_MLModelProvision services.

Example 28 may include the method of example 21 and/or some other example herein, further comprising providing Nnwdaf_MLModelTraining services or Nnwdaf_MLModel_DistributedTraining services.

Example 29 may include the method of example 21 and/or some other example herein, further comprising generating an access token including NF instance ID of NRF, NF Instance ID of the NF service consumer, NF type of an NF service producer, expected service name(s), expiration time, FL group ID, Analytics ID(s), and ML model ID(s).

Example 30 may include the method of example 21 and/or some other example herein, further comprising including CCA_NWDAF for authentication.

Example 31 may include an apparatus comprising means for: receiving a request for an access token from a network function (NF) service consumer to request network data analytics function (NWDAF) model training logical function (MTLF) (federated learning (FL) Server) services; validating the access token associated with the NWDAF; initiating an FL group based on the validated access token; starting the FL group for analytics identification (ID); sending a request to get an NF repository function (NRF) access token from an NRF; finalizing the FL group with the NWDAF MTLF (FL Client) selected from a list received from the NRF; requesting service from the NWDAF MTLF (FL Client); authenticating the NF service consumer and verify the access token; performing global model updates and aggregation; and providing an NF service response to the NF service consumer.

Example 32 may include the apparatus of example 31 and/or some other example herein, wherein the NF service consumer may be an NWDAF AnLF or MTLF service consumer.

Example 33 may include the apparatus of example 31 and/or some other example herein, wherein the access token may be an access_token_nwdaf.

Example 34 may include the apparatus of example 31 and/or some other example herein, wherein the NRF access token may include information to identify the target NF (NWDAF MTLF (FL Client)), the NF Service Consumer), NF Instance ID of NWDAF MTLF (FL Server), Analytics ID, FL local model training service type, FL group ID, and a CCA_NWDAF provided by the NF service consumer.

Example 35 may include the apparatus of example 31 and/or some other example herein, wherein authenticating the NF service consumer and verifying the access token further comprises means for ensuring that the NWDAF MTLF (FL Server) identity, FL group ID, Analytics ID(s), ML model ID(s) are included as an access token.

Example 36 may include the apparatus of example 31 and/or some other example herein, wherein sending the request to get the NF repository function (NRF) access token from the NRF further comprises means for identifying a target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer.

Example 37 may include the apparatus of example 31 and/or some other example herein, further comprising providing Nnwdaf_MLModelProvision services.

Example 38 may include the apparatus of example 31 and/or some other example herein, further comprising providing Nnwdaf_MLModelTraining services or Nnwdaf_MLModel_DistributedTraining services.

Example 39 may include the apparatus of example 31 and/or some other example herein, further comprising generating an access token including NF instance ID of NRF, NF Instance ID of the NF service consumer, NF type of an NF service producer, expected service name(s), expiration time, FL group ID, Analytics ID(s), and ML model ID(s).

Example 40 may include the apparatus of example 31 and/or some other example herein, further comprising including CCA_NWDAF for authentication.

Example 41 may include an apparatus comprising means for performing any of the methods of examples 1-40.

Example 42 may include a network node comprising a communication interface and processing circuitry connected thereto and configured to perform the methods of examples 1-40.

Example 43 may include an apparatus comprising means to perform one or more elements of a method described in or related to any of examples 1-40, or any other method or process described herein.

Example 44 may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Example 45 may include an apparatus comprising logic, modules, or circuitry to perform one or more elements of a method described in or related to any of examples 1-40, or any other method or process described herein.

Example 46 may include a method, technique, or process as described in or related to any of examples 1-40, or portions or parts thereof.

Example 47 may include an apparatus comprising: one or more processors and one or more computer-readable media comprising instructions that, when executed by the one or more processors, cause the one or more processors to perform the method, techniques, or process as described in or related to any of examples 1-40, or portions thereof.

Example 48 may include a signal as described in or related to any of examples 1-40, or portions or parts thereof.

Example 49 may include a datagram, packet, frame, segment, protocol data unit (PDU), or message as described in or related to any of examples 1-40, or portions or parts thereof, or otherwise described in the present disclosure.

Example 50 may include a signal encoded with data as described in or related to any of examples 1-40, or portions or parts thereof, or otherwise described in the present disclosure.

Example 51 may include a signal encoded with a datagram, packet, frame, segment, protocol data unit (PDU), or message as described in or related to any of examples 1-40, or portions or parts thereof, or otherwise described in the present disclosure.

Example 52 may include an electromagnetic signal carrying computer-readable instructions, wherein execution of the computer-readable instructions by one or more processors is to cause the one or more processors to perform the method, techniques, or process as described in or related to any of examples 1-40, or portions thereof.

Example 53 may include a computer program comprising instructions, wherein execution of the program by a processing element is to cause the processing element to carry out the method, techniques, or process as described in or related to any of examples 1-40, or portions thereof.

Example 54 may include a signal in a wireless network as shown and described herein.

Example 55 may include a method of communicating in a wireless network as shown and described herein.

Example 56 may include a system for providing wireless communication as shown and described herein.

Example 57 may include a device for providing wireless communication as shown and described herein.

An example implementation is an edge computing system, including respective edge processing devices and nodes to invoke or perform the operations of the examples above, or other subject matter described herein. Another example implementation is a client endpoint node, operable to invoke or perform the operations of the examples above, or other subject matter described herein. Another example implementation is an aggregation node, network hub node, gateway node, or core data processing node, within or coupled to an edge computing system, operable to invoke or perform the operations of the examples above, or other subject matter described herein. Another example implementation is an access point, base station, road-side unit, street-side unit, or on-premise unit, within or coupled to an edge computing system, operable to invoke or perform the operations of the examples above, or other subject matter described herein. Another example implementation is an edge provisioning node, service orchestration node, application orchestration node, or multi-tenant management node, within or coupled to an edge computing system, operable to invoke or perform the operations of the examples above, or other subject matter described herein, Another example implementation is an edge node operating an edge provisioning service, application or service orchestration service, virtual machine deployment, container deployment, function deployment, and compute management, within or coupled to an edge computing system, operable to invoke or perform the operations of the examples above, or other subject matter described herein. Another example implementation is an edge computing system operable as an edge mesh, as an edge mesh with side car loading, or with mesh-to-mesh communications, operable to invoke or perform the operations of the examples above, or other subject matter described herein. Another example implementation is an edge computing system including aspects of network functions, acceleration functions, acceleration hardware, storage hardware, or computation hardware resources, operable to invoke or perform the use cases discussed herein, with use of the examples above, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples above, or other subject matter described herein. Another example implementation is an edge computing system adapted for mobile wireless communications, including configurations according to an 3GPP 4G/LTE or 5G network capabilities, operable to invoke or perform the use cases discussed herein, with use of the examples above, or other subject matter described herein. Another example implementation is a computing system adapted for network communications, including configurations according to an O-RAN capabilities, operable to invoke or perform the use cases discussed herein, with use of the examples above, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [6], that enables operator and 3rd party services to be hosted close to the UE's access point of attachment, to achieve an efficient service delivery through the reduced end-to-end latency and load on the transport network. As used herein, the term “Edge Computing Service Provider” refers to a mobile network operator or a 3rd party service provider offering Edge Computing service. As used herein, the term “Edge Data Network” refers to a local Data Network (DN) that supports the architecture for enabling edge applications. As used herein, the term “Edge Hosting Environment” refers to an environment providing support required for Edge Application Server's execution. As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

An “information object,” as used herein, refers to a collection of structured data and/or any representation of information, and may include, for example electronic documents (or “documents”), database objects, data structures, files, audio data, video data, raw data, archive files, application packages, and/or any other like representation of information. The terms “electronic document” or “document,” may refer to a data structure, computer file, or resource used to record data, and includes various file types and/or data formats such as word processing documents, spreadsheets, slide presentations, multimedia items, webpage and/or source code documents, and/or the like. As examples, the information objects may include markup and/or source code documents such as HTML, XML, JSON, Apex®, CSS, JSP, MessagePack™, Apache® Thrift™, ASN.1, Google® Protocol Buffers (protobuf), or some other document(s)/format(s) such as those discussed herein. An information object may have both a logical and a physical structure. Physically, an information object comprises one or more units called entities. An entity is a unit of storage that contains content and is identified by a name. An entity may refer to other entities to cause their inclusion in the information object. An information object begins in a document entity, which is also referred to as a root element (or “root”). Logically, an information object comprises one or more declarations, elements, comments, character references, and processing instructions, all of which are indicated in the information object (e.g., using markup).

The term “data item” as used herein refers to an atomic state of a particular object with at least one specific property at a certain point in time. Such an object is usually identified by an object name or object identifier, and properties of such an object are usually defined as database objects (e.g., fields, records, etc.), object instances, or data elements (e.g., mark-up language elements/tags, etc.). Additionally or alternatively, the term “data item” as used herein may refer to data elements and/or content items, although these terms may refer to difference concepts. The term “data element” or “element” as used herein refers to a unit that is indivisible at a given level of abstraction and has a clearly defined boundary. A data element is a logical component of an information object (e.g., electronic document) that may begin with a start tag (e.g., “<element>”) and end with a matching end tag (e.g., “</element>”), or only has an empty element tag (e.g., “<element/>”). Any characters between the start tag and end tag, if any, are the element's content (referred to herein as “content items” or the like).

The content of an entity may include one or more content items, each of which has an associated datatype representation. A content item may include, for example, attribute values, character values, URIs, qualified names (qnames), parameters, and the like. A qname is a fully qualified name of an element, attribute, or identifier in an information object. A qname associates a URI of a namespace with a local name of an element, attribute, or identifier in that namespace. To make this association, the qname assigns a prefix to the local name that corresponds to its namespace. The qname comprises a URI of the namespace, the prefix, and the local name. Namespaces are used to provide uniquely named elements and attributes in information objects. Content items may include text content (e.g., “<element>content item</element>”), attributes (e.g., “<element attribute=” attributeValue “>”), and other elements referred to as “child elements” (e.g., “<element1> <element2>content item</element2> </element1>”). An “attribute” may refer to a markup construct including a name-value pair that exists within a start tag or empty element tag. Attributes contain data related to its element and/or control the element's behavior.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.11ay, etc.), V2X communication technologies (including 3GPP C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The term “SMTC” refers to an SSB-based measurement timing configuration configured by SSB-MeasurementTimingConfiguration. The term “SSB” refers to a synchronization signal/Physical Broadcast Channel (SS/PBCH) block, which includes a Primary Syncrhonization Signal (PSS), a Secondary Syncrhonization Signal (SSS), and a PBCH. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “A1 policy” refers to a type of declarative policies expressed using formal statements that enable the non-RT RIC function in the SMO to guide the near-RT RIC function, and hence the RAN, towards better fulfilment of the RAN intent.

The term “A1 Enrichment information” refers to information utilized by near-RT RIC that is collected or derived at SMO/non-RT RIC either from non-network data sources or from network functions themselves.

The term “A1-Policy Based Traffic Steering Process Mode” refers to an operational mode in which the Near-RT RIC is configured through A1 Policy to use Traffic Steering Actions to ensure a more specific notion of network performance (for example, applying to smaller groups of E2 Nodes and UEs in the RAN) than that which it ensures in the Background Traffic Steering.

The term “Background Traffic Steering Processing Mode” refers to an operational mode in which the Near-RT RIC is configured through O1 to use Traffic Steering Actions to ensure a general background network performance which applies broadly across E2 Nodes and UEs in the RAN.

The term “Baseline RAN Behavior” refers to the default RAN behavior as configured at the E2 Nodes by SMO

The term “E2” refers to an interface connecting the Near-RT RIC and one or more O-CU-CPs, one or more O-CU-UPs, one or more O-DUs, and one or more O-eNBs.

The term “E2 Node” refers to a logical node terminating E2 interface. In this version of the specification, ORAN nodes terminating E2 interface are: for NR access: O-CU-CP, O-CU-UP, O-DU or any combination; and for E-UTRA access: O-eNB.

The term “Intents”, in the context of O-RAN systems/implementations, refers to declarative policy to steer or guide the behavior of RAN functions, allowing the RAN function to calculate the optimal result to achieve stated objective.

The term “O-RAN non-real-time RAN Intelligent Controller” or “non-RT RIC” refers to a logical function that enables non-real-time control and optimization of RAN elements and resources, AI/ML workflow including model training and updates, and policy-based guidance of applications/features in Near-RT RIC.

The term “Near-RT RIC” or “O-RAN near-real-time RAN Intelligent Controller” refers to a logical function that enables near-real-time control and optimization of RAN elements and resources via fine-grained (e.g., UE basis, Cell basis) data collection and actions over E2 interface.

The term “O-RAN Central Unit” or “O-CU” refers to a logical node hosting RRC, SDAP and PDCP protocols.

The term “O-RAN Central Unit-Control Plane” or “O-CU-CP” refers to a logical node hosting the RRC and the control plane part of the PDCP protocol.

The term “O-RAN Central Unit-User Plane” or “O-CU-UP” refers to a logical node hosting the user plane part of the PDCP protocol and the SDAP protocol

The term “O-RAN Distributed Unit” or “O-DU” refers to a logical node hosting RLC/MAC/High-PHY layers based on a lower layer functional split.

The term “O-RAN eNB” or “O-eNB” refers to an eNB or ng-eNB that supports E2 interface.

The term “O-RAN Radio Unit” or “O-RU” refers to a logical node hosting Low-PHY layer and RF processing based on a lower layer functional split. This is similar to 3GPP's “TRP” or “RRH” but more specific in including the Low-PHY layer (FFT/iFFT, PRACH extraction).

The term “O1” refers to an interface between orchestration & management entities (Orchestration/NMS) and O-RAN managed elements, for operation and management, by which FCAPS management, Software management, File management and other similar functions shall be achieved.

The term “RAN UE Group” refers to an aggregations of UEs whose grouping is set in the E2 nodes through E2 procedures also based on the scope of A1 policies. These groups can then be the target of E2 CONTROL or POLICY messages.

The term “Traffic Steering Action” refers to the use of a mechanism to alter RAN behavior. Such actions include E2 procedures such as CONTROL and POLICY.

The term “Traffic Steering Inner Loop” refers to the part of the Traffic Steering processing, triggered by the arrival of periodic TS related KPM (Key Performance Measurement) from E2 Node, which includes UE grouping, setting additional data collection from the RAN, as well as selection and execution of one or more optimization actions to enforce Traffic Steering policies.

The term “Traffic Steering Outer Loop” refers to the part of the Traffic Steering processing, triggered by the near-RT RIC setting up or updating Traffic Steering aware resource optimization procedure based on information from A1 Policy setup or update, A1 Enrichment Information (EI) and/or outcome of Near-RT RIC evaluation, which includes the initial configuration (preconditions) and injection of related A1 policies, Triggering conditions for TS changes.

The term “Traffic Steering Processing Mode” refers to an operational mode in which either the RAN or the Near-RT RIC is configured to ensure a particular network performance. This performance includes such aspects as cell load and throughput, and can apply differently to different E2 nodes and UEs. Throughout this process, Traffic Steering Actions are used to fulfill the requirements of this configuration.

The term “Traffic Steering Target” refers to the intended performance result that is desired from the network, which is configured to Near-RT RIC over O1.

Furthermore, any of the disclosed embodiments and example implementations can be embodied in the form of various types of hardware, software, firmware, middleware, or combinations thereof, including in the form of control logic, and using such hardware or software in a modular or integrated manner. Additionally, any of the software components or functions described herein can be implemented as software, program code, script, instructions, etc., operable to be executed by processor circuitry. These components, functions, programs, etc., can be developed using any suitable computer language such as, for example, Python, PyTorch, NumPy, Ruby, Ruby on Rails, Scala, Smalltalk, Java™, C++, C#, “C”, Kotlin, Swift, Rust, Go (or “Golang”), EMCAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, and/or any other programming language or development tools including proprietary programming languages and/or development tools. The software code can be stored as a computer- or processor-executable instructions or commands on a physical non-transitory computer-readable medium. Examples of suitable media include RAM, ROM, magnetic media such as a hard-drive or a floppy disk, or an optical medium such as a compact disk (CD) or DVD (digital versatile disk), flash memory, and the like, or any combination of such storage or transmission devices.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

TABLE 1
Abbreviations:

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital Expenditure |
| CBD | Candidate Beam Detection |
| CBRA | Contention Based Random Access |
| CC | Component Carrier, Country Code, Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB centralized unit |
| gNB-DU | gNB-distributed unit, Next Generation NodeB distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |
| | Constraint length of the convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption context) |
| MAC-A | MAC used for authentication and key agreement (TSG TWG3 context) |
| MAC-I | MAC used for data integrity of signalling messages (TSG TWG3 context) |
| MANO | Management and Orchestration |
| MBMS | Multimedia Broadcast and Multicast Service |
| MBSFN | Multimedia Broadcast multicast service Single Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWDAF | Network Data Analytics Function |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, |
| | Packet Data Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSFCH | physical sidelink feedback channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| 4SS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining |
| | Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, |
| | Service Data Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, |
| | SFN and frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block |
| SSBRI | SS/PBCH Block Resource Indicator, |
| | Synchronization Signal Block Resource Indicator |
| SSC | Session and Service Continuity |
| SS-RSRP | Synchronization Signal based Reference Signal Received Power |
| SS-RSRQ | Synchronization Signal based Reference Signal Received Quality |
| SS-SINR | Synchronization Signal based Signal to Noise and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Po |

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

What is claimed is:

1. An apparatus for a network data analytics function (NWDAF) comprising:
processing circuitry configured to:
receive a request for an access token from a network function (NF) service consumer to request NWDAF model training logical function (MTLF) (federated learning (FL) Server) services;
validate the access token associated with the NWDAF;
send a request to get an NF repository function (NRF) access token from an NRF;
finalize the FL group with the NWDAF MTLF (FL Client) selected from a list received from the NRF;
request service from the NWDAF MTLF (FL Client);
authenticate the NF service consumer and verify the access token; and
provide an NF service response to the NF service consumer; and
a memory to store the access token.

2. The apparatus of claim 1, wherein the NF service consumer is an NWDAF AnLF or MTLF service consumer.

3. The apparatus of claim 1, wherein the access token is an access_token_nwdaf.

4. The apparatus of claim 1, wherein the NRF access token includes information to identify the target NF (NWDAF MTLF (FL Client)), the NF Service Consumer), NF Instance ID of NWDAF MTLF (FL Server), Analytics ID, FL local model training service type, FL group ID, and a CCA_NWDAF provided by the NF service consumer.

5. The apparatus of claim 1, wherein to authenticate the NF service consumer and verify the access token comprises the processing circuitry being further configured to ensure that the NWDAF MTLF (FL Server) identity, FL group ID, Analytics ID(s), ML model ID(s) are included as an access token.

6. The apparatus of claim 1, wherein to wherein send a request to get an NF repository function (NRF) access token from an NRF comprises the processing circuitry being further configured to identify a target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer.

7. The apparatus of claim 1, wherein the processing circuitry is further configured to provide Nnwdaf_MLModelProvision services.

8. The apparatus of claim 7, wherein the processing circuitry is further configured to provide Nnwdaf_MLModelTraining services or Nnwdaf_MLModel_DistributedTraining services.

9. A non-transitory computer-readable medium storing computer-executable instructions which when executed by one or more processors result in performing operations comprising:
receiving a request for an access token from a network function (NF) service consumer to request network data analytics function (NWDAF) model training logical function (MTLF) (federated learning (FL) Server) services;
validating the access token associated with the NWDAF;
sending a request to get an NF repository function (NRF) access token from an NRF;
finalizing the FL group with the NWDAF MTLF (FL Client) selected from a list received from the NRF;
requesting service from the NWDAF MTLF (FL Client);
authenticating the NF service consumer and verify the access token; and
providing an NF service response to the NF service consumer.

10. The non-transitory computer-readable medium of claim 9, wherein the NF service consumer is an NWDAF AnLF or MTLF service consumer.

11. The non-transitory computer-readable medium of claim 9, wherein the access token is an access_token_nwdaf.

12. The non-transitory computer-readable medium of claim 9, wherein the NRF access token includes information to identify the target NF (NWDAF MTLF (FL Client)), the NF Service Consumer), NF Instance ID of NWDAF MTLF (FL Server), Analytics ID, FL local model training service type, FL group ID, and a CCA_NWDAF provided by the NF service consumer.

13. The non-transitory computer-readable medium of claim 9, wherein the operations for authenticating the NF service consumer and verifying the access token further comprise ensuring that the NWDAF MTLF (FL Server) identity, FL group ID, Analytics ID(s), ML model ID(s) are included as an access token.

14. The non-transitory computer-readable medium of claim 9, wherein the operations for sending the request to get an NF repository function (NRF) access token from the NRF further comprise identifying a target NF (NWDAF MTLF (FL Client)), source NF service consumer, NF Instance ID of NWDAF MTLF (FL Server), Analytics ID, FL local model training service type, FL group ID, and a CCA_NWDAF provided by the NF service consumer.

15. The non-transitory computer-readable medium of claim 9, wherein the operations further comprise providing Nnwdaf_MLModelProvision services.

16. The non-transitory computer-readable medium of claim 15, wherein the operations further comprise providing Nnwdaf_MLModelTraining services or Nnwdaf_MLModel_DistributedTraining services.

17. A method comprising:
receiving, by one or more processors, a request for an access token from a network function (NF) service consumer to request network data analytics function (NWDAF) model training logical function (MTLF) (federated learning (FL) Server) services;
validating the access token associated with the NWDAF;
sending a request to get an NF repository function (NRF) access token from an NRF;
finalizing the FL group with the NWDAF MTLF (FL Client) selected from a list received from the NRF;
requesting service from the NWDAF MTLF (FL Client);
authenticating the NF service consumer and verify the access token; and
providing an NF service response to the NF service consumer.

18. The method of claim 17, wherein the NF service consumer is an NWDAF AnLF or MTLF service consumer.

19. An apparatus comprising means for performing the method of claim 18.

20. A network node comprising a communication interface and processing circuitry connected thereto and configured to perform the method of claim 18.
